(19) United States
(12) Patent Application Publication
(10) Pub. No.: US 2023/0306290 A1
(43) Pub. Date: Sep. 28, 2023

(54) APPROXIMATED OBJECTIVE FUNCTION FOR MONTE CARLO ALGORITHM

(71) Applicant: Microsoft Technology Licensing, LLC, Redmond, WA (US)

(72) Inventors: Firas HAMZE, Vancouver (CA); Jonathan Lee MACHTA, Amherst, MA (US)

(73) Assignee: Microsoft Technology Licensing, LLC, Redmond, WA (US)

(21) Appl. No.: 17/655,773

(22) Filed: Mar. 21, 2022

(51) Int. Cl. G06N 7/00; G06N 20/00

(52) U.S. Cl. CPC G06N 7/005; G06N 20/00

(57) ABSTRACT

A computing device including a processor configured to receive an exact objective function over a state space. The processor may receive an approximated objective function that approximates the exact objective function. The processor may compute an estimated optimal state of the exact objective function. Computing the estimated optimal state may include, starting at an initial state, computing a preliminary estimated optimal state by performing a plurality of fast-step iterations of a Monte Carlo algorithm with respective fast-step acceptance probabilities determined based at least in part on the approximated objective function. Computing the estimated optimal state may further include performing a correction iteration that has a correction-step acceptance probability determined based at least in part on respective values of the approximated objective function and the exact objective function computed at the preliminary estimated optimal state. The processor may output the estimated optimal state.

### BACKGROUND

Optimization problems are found in many areas such as engineering, electrical grid management, and computing resource allocation. When solving these optimization problems, a maximum or minimum of an objective function is computed over a state space given by the input variables of the objective function. In many instances, exact solutions to an optimization problem would be unfeasible to compute due to the size of the state space over which a search for the maximum or minimum would have to be performed. Thus, computational methods of estimating solutions to optimization problems have been developed.

### SUMMARY

According to one aspect of the present disclosure, a computing device is provided, including a processor configured to receive an exact objective function over a state space. The processor may be further configured to receive an approximated objective function that approximates the exact objective function. The processor may be further configured to compute an estimated optimal state of the exact objective function at least by, starting at an initial state, computing a preliminary estimated optimal state by performing a plurality of fast-step iterations of a Monte Carlo algorithm with respective fast-step acceptance probabilities that are determined based at least in part on the approximated objective function. Computing the estimated optimal state may further include performing a correction iteration that has a correction-step acceptance probability determined based at least in part on respective values of the approximated objective function and the exact objective function computed at the preliminary estimated optimal state. The processor may be further configured to output the estimated optimal state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing device including a processor at which an estimated optimal state of an exact objective function may be computed, according to one example embodiment.

FIG. 2 shows an example GUI at which a user may specify an approximated objective function, according to the example of FIG. 1.

FIG. 3 schematically shows a fast-step iteration that may be performed by the processor when executing a Metropolis-Hastings algorithm, according to the example of FIG. 1.

FIG. 4 schematically shows a correction iteration that follows the plurality of fast-step iterations, according to the example of FIG. 3.

FIG. 5 schematically shows the computing device when the approximated objective function is a machine learning model trained to simulate the exact objective function, according to the example of FIG. 1.

FIG. 6 schematically depicts a fast-step iteration in an example in which the processor is configured to compute the preliminary estimated optimal state based at least in part on a sequence of one or more prior states, according to the example of FIG. 1.

FIG. 7 shows a flowchart of a method for use with a computing device to compute an estimated solution to an optimization problem, according to the example of FIG. 1.

FIG. 8 shows a schematic view of an example computing environment in which the computing device of FIG. 1 may be instantiated.

### DETAILED DESCRIPTION

Many existing approaches to estimating solutions to optimization problems utilize Monte Carlo sampling. In Monte Carlo sampling, a computing system iteratively samples random or pseudorandom values from a probability distribution over the state space of the objective function. The computing system computes respective values of the objective function for the sampled values. Based on the computed values of the objective function, the computing system iteratively updates the probability distribution from which the input values are sampled. After some number of iterations, the computing system outputs the sampled values with which the value of the objective function is computed. Thus, the computing system estimates a state within the state space at which the objective function has a maximum or minimum value.

In existing optimization algorithms, it is typically assumed that the exact value of the objective function is feasible to compute for a large number of sampled values. However, this assumption does not hold for all objective functions. For example, evaluating an objective function may, in some examples, involve computing a solution to another optimization problem. As another example, evaluating the objective function may include performing inferencing at a large machine learning model. When the obj ective function has a high computational cost in terms of processor utilization, memory utilization, or computing time, estimating a solution to an optimization problem using conventional methods may be highly resource-intensive, requiring both large amounts of processing time and memory to complete. This increases the cost, delay, and environmental impact of the computations.

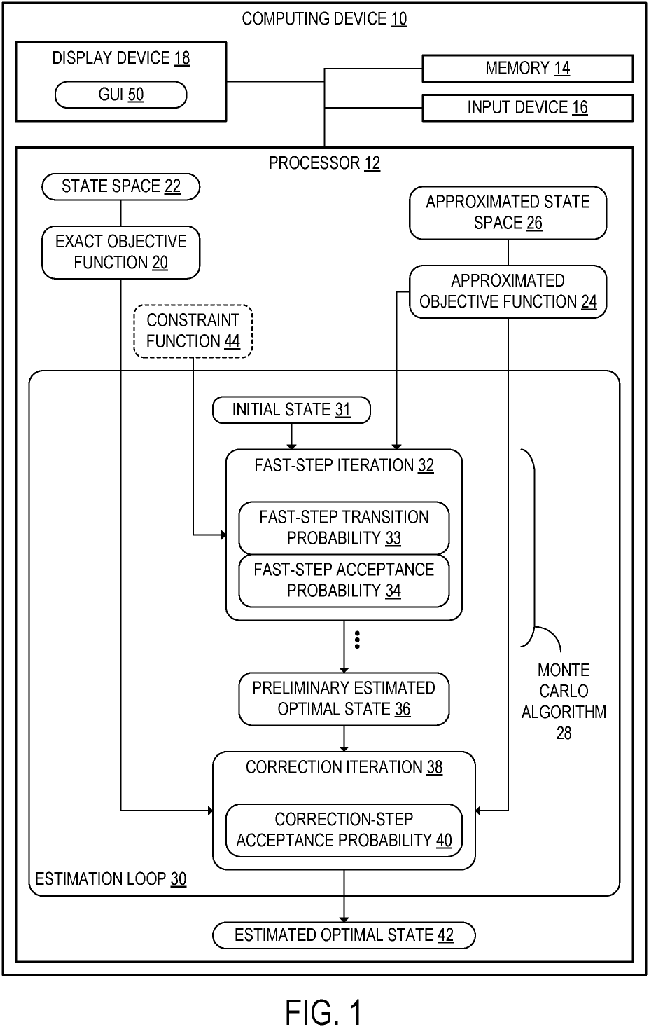

In order to address the above challenges, a computing device 10 is provided, as schematically shown in the example of FIG. 1. The computing device 10 may include a processor 12 configured to execute instructions to perform computing processes. For example, the processor 12 may include one or more central processing units (CPUs), graphical processing units (GPUs), field-programmable gate arrays (FPGAs), specialized hardware accelerators, and/or other types of processing devices. The computing device 10 may further include memory 14 that is communicatively coupled to the processor 12. The memory 14 may, for example, include one or more volatile memory devices and/or one or more non-volatile memory devices.

Other components, such as user input devices 16 and/or user output devices, may also be included in the computing device 10. The one or more input devices 16 may, for example, include a keyboard, a mouse, a touchscreen, a microphone, an accelerometer, an optical sensor, and/or other types of input devices. The one or more output devices may include a display device 18 configured to display a graphical user interface (GUI) 50. At the GUI 50, the user may view outputs of computing processes executed at the processor 12. The user may also provide user input to the processor 12 by interacting with the GUI 50 via the one or more input devices 16. One or more other types of output devices, such as a speaker or a haptic feedback device, may additionally or alternatively be included in the computing device 10.

The computing device 10 may be instantiated in a single physical computing device or in a plurality of communicatively coupled physical computing devices. For example, the computing device 10 may be provided as a physical or virtual server computing device located at a data center. In examples in which the computing device 10 is a virtual server computing device, the functionality of the processor 12 and/or the memory 14 may be distributed between a plurality of physical computing devices. The computing device 10 may, in some examples, be instantiated at least in part at one or more client computing devices. The one or more client computing devices may be configured to communicate with the one or more server computing devices over a network.

The processor 12 of the computing device 10 may be configured to receive an exact objective function 20 over a state space 22. The state space 22 of the exact objective function 20 is the domain of inputs for which the value of the exact objective function 20 may be computed. The exact objective function 20 may be a function of one variable or multiple variables.

The processor 12 may be further configured to receive an approximated objective function 24 that approximates the exact objective function 20. The approximated objective function 24 is a function over an approximated state space 26, which may be the same as or different from the state space 22 of the exact objective function 20. In some examples, the number of variables of the approximated state space 26 may be lower than the number of variables of the state space 22. For example, one or more of the variables over which the exact objective function 20 is configured to be computed may be held constant in the approximated obj ective function 24. Additionally or alternatively, one or more of the variables of the approximated objective function 24 may have a smaller set of possible values while still being allowed to vary.

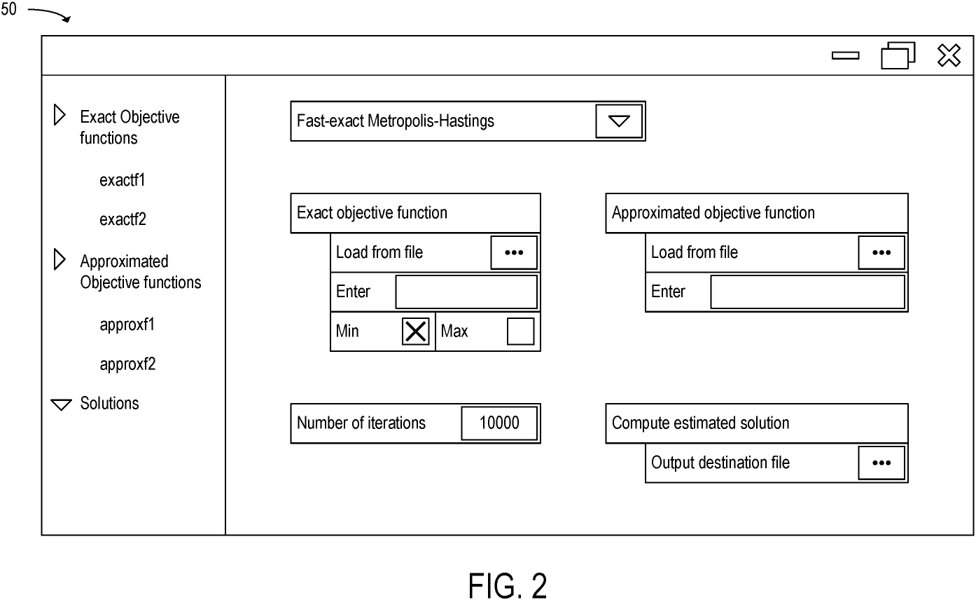

The approximated objective function 24 may, in some examples, be specified by the user at the GUI 50. FIG. 2 shows an example GUI 50 at which the user may specify the approximated objective function 24. The example GUI 50 shown in FIG. 2 includes interface elements at which the user may select an optimization algorithm, input the exact objective function 20 and the approximated objective function 24, specify a number of iterations for which the processor 12 is configured to perform the optimization algorithm, and generate instructions to compute the estimated solution to the exact objective function 20. When the user inputs the exact objective function 20 and the approximated objective function 24 by interacting with the GUI 50, the user may load the exact objective function 20 and/or the approximated objective function 24 from respective files. Alternatively, the user may enter the exact objective function 20 and/or the approximated objective function 24 directly at the GUI 50. The user may further specify whether the processor is configured to estimate a minimum or a maximum of the exact objective function 20. In addition, the user may specify an output destination file to which the processor 12 is configured to output the estimated solution.

In some examples, rather than receiving the approximated objective function 24 via user input to the GUI 50, the processor 12 may instead be configured to programmatically generate the approximated objective function 24 from the exact objective function 20. For example, when the exact objective function 20 is expressed as a sum of a plurality of terms with respective weights, the processor 12 may be configured to exclude one or more terms that are below a predefined weight threshold or are not included in a predetermined number of largest weights. As another example, the approximated objective function 24 may be generated as a Taylor series expansion of the exact objective function 20. In yet another example, when the exact objective function 20 includes a matrix, the processor 12 may be configured to compute a low-rank approximate of that matrix and replace the matrix with the low-rank approximation in the approximated objective function 24. Other types of approximations may additionally or alternatively be used when the approximated objective function 24 is computed.

Returning to FIG. 1, the processor 12 may be further configured to compute an estimated optimal state 42 of the exact objective function 20. The estimated optimal state 42 may be a minimum or a maximum of the exact objective function 20. The processor 12 may be configured to compute the estimated optimal state 42 by performing one or more iterations of an estimation loop 30 that includes a plurality of fast-step iterations 32 and a correction iteration 38. As discussed in further detail below, the plurality of fast-step iterations 32 may each have a respective fast-step transition probability 33 and a respective fast-step acceptance probability 34. The correction iteration 38 may have a correction-step acceptance probability 40. The estimation loop 30 may be repeated until the correction iteration 38 is accepted, at which point the processor 12 may be further configured to output the state accepted during the correction iteration 38 as the estimated optimal state 42. The estimated optimal state 42 may be output to an additional computing process, such as the GUI 50, an automated electrical grid management program, or an automated computing resource allocation program. As another example, the processor 12 may be configured to output the estimated optimal state 42 to a neural network architecture search program.

Computing the estimated optimal state 42 may include computing a preliminary estimated optimal state 36 based at least in part on the approximated objective function 24. The preliminary estimated optimal state 36 may be computed starting at an initial state 31 in the approximated state space 26. The processor 12 may be configured to compute the preliminary estimated optimal state 36 by performing a plurality of fast-step iterations 32 of a Monte Carlo algorithm 28. The Monte Carlo algorithm 28 may be a Markov chain Monte Carlo (MCMC) algorithm. For example, the MCMC algorithm may be a Metropolis-Hastings algorithm, a simulated annealing algorithm, a simulated quantum annealing algorithm (e.g., a path-integral quantum Monte Carlo), a parallel tempering algorithm, or a population annealing algorithm.

In some examples, during each of the fast-step iterations 32 of the Monte Carlo algorithm 28, the processor 12 may be configured to sample from a Gibbs distribution over the approximated state space 26 of the approximated objective function 24. The Gibbs distribution is a probability distribution given by

$${p}_{β} \left(x\right) = \frac{{e}^{- β \text{} E \left(x\right)}}{Z \left(β\right)}$$

where x ∈ X is the state of the system, E(x) is the objective function, and β is an inverse temperature. Z(β) is a partition function of the system given by

$$Z \left(β\right) = {\sum }_{x ∈ X} {e}^{- β \text{} E \left(x\right)}$$

Accordingly, the partition function Z(β) normalizes the probability distribution. At high values of β, which correspond to low temperatures, the Gibbs distribution is concentrated around a lowest-energy state that corresponds to a minimum of the objective function E(x). However, estimated solutions may fail to converge when directly sampling from the Gibbs distribution at large values of β. Thus, the MCMC algorithm may utilize distributions with lower values of β that are used to select states at which the processor 12 performs sampling with high values of β. The MCMC algorithm may produce a sequence of states such that, starting from an arbitrary initial state, the sequence of states accurately approximates the target distribution.

The steps of the Metropolis-Hastings algorithm are discussed below. In each iteration of the Metropolis-Hastings algorithm, given a current state x, an updated state x′ is proposed with a probability P(x → x′). These probabilities may be normalized, such that

$${∀}_{x} {\sum }_{{x}^{′} ∈ X} P \left(x \to {x}^{′}\right) = 1$$

In addition, the probabilities P(x → x′) may be reversible, with

$$P \left(x \to {x}^{′}\right) = P \left({x}^{′} \to x\right)$$

The probabilities P(x → x′) may be computed from the Gibbs distribution in some examples, as discussed above. In other examples, some other probability distribution may instead be used.

Each iteration of the Metropolis-Hastings algorithm also has an acceptance probability A(x → x′). With probability, A(x → x′), the system transitions to the updated state x′. The acceptance probability may be given by

$$A \left(x \to {x}^{′}\right) = min \left[1 , {e}^{- β \text{} \text{Δ} E}\right]$$

where ΔE = E(x′) - E(x) is the change in the value of the objective function between the current state x and the updated state x′. In this example, the updated state x′ is always accepted when the value of the objective function E decreases. The overall transition probability W(x → x′) of the Metropolis-Hastings algorithm is given by

$$W \left(x \to {x}^{′}\right) = P \left(x \to {x}^{′}\right) A \left(x \to {x}^{′}\right) \text{if} {x}^{′} \neq x$$

and

$$W \left(x \to x\right) = 1 - {\sum }_{{x}^{′} ∈ X \backslash \left\{x\right\}} W \left(x \to {x}^{′}\right)$$

where W (x → x) is determined by normalization of the transition probabilities. Over the course of k fast-step iterations 32, the states x₀, ... xₖ are visited, starting with the initial state 31 as x₀ and ending with the preliminary estimated optimal state 36 as xₖ.

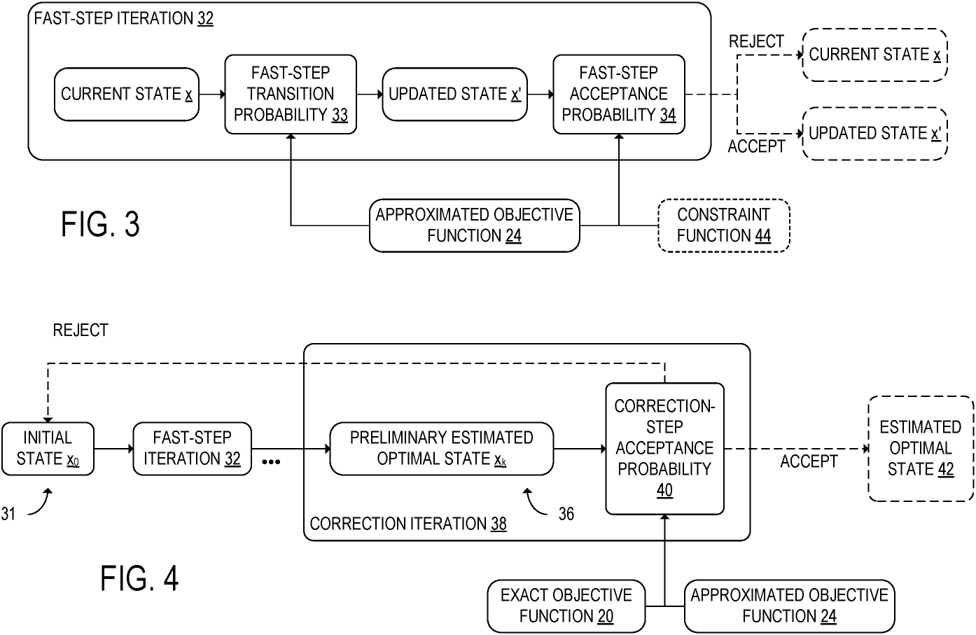

FIG. 3 schematically shows a fast-step iteration 32 in an example in which the Monte Carlo algorithm 28 is the Metropolis-Hastings algorithm. As shown in the example of FIG. 3, the processor 12 may be configured to compute a fast-step transition probability 33 for a current state x and an updated state x′ and to propose that updated state x′ with the fast-step transition probability 33. The fast-step transition probability may be computed from a Gibbs distribution over the approximated obj ective function 24.

The processor 12 may be further configured to compute the fast-step acceptance probability for the current state x and the updated state x′. The processor 12 may compute the fast-step acceptance probability as

$$\tilde{A} \left(x \to {x}^{′}\right) = min \left[1 , {e}^{- β \text{Δ} \tilde{E}}\right]$$

In the above equation, the approximated objective function 24 is denoted as Ẽ, and ΔẼ is a change in a value of the approximated objective function Ẽ between the current state x and the updated state x′. The change in the value of the approximated objective function Ẽ may be computed as ΔẼ = Ẽ(x′) - Ẽ(x).

When the transition is accepted, the processor 12 may be configured to use the updated state x′ as the current state x in the next fast-step iteration 32, or, when the current fast-step iteration 32 is the last fast-step iteration 32 in the estimation loop 30, select the updated state x′ as the preliminary estimated optimal state 36. When the transition is rejected, the processor 12 may be configured to instead remain at the current state x.

FIG. 4 schematically shows a correction iteration 38 that follows the plurality of fast-step iterations 32 in the estimation loop 30. As shown in the example of FIG. 4, the processor 12 may be configured to perform the plurality of fast-step iterations 32, starting with the initial state x₀, to compute the preliminary estimated optimal state xₖ. The preliminary estimated optimal state 36 may then be used as an input to the correction iteration 38. During the correction iteration 38, as discussed in further detail below, the processor 12 may be configured to determine whether to accept the preliminary estimated optimal state xₖ or return to the initial state x₀. Thus, during the correction iteration 38, the initial state x₀ may be analogous to the current state x in a fast-step iteration 32, and the preliminary estimated optimal state 36 may be analogous to the updated state x′.

When the correction iteration 38 is performed, the processor 12 may be configured to compute the correction-step acceptance probability 40. The correction-step acceptance probability 40 determined based at least in part on respective values of the approximated objective function 24 and the exact objective function 20 computed at the preliminary estimated optimal state xₖ. In addition, the correction-step acceptance probability 40 may be based at least in part on the respective values of the approximated objective function 24 and the exact objective function 20 computed at the initial state x₀. Thus, the correction-step acceptance probability 40 may be given by

$${A}_{s} \left(x \to {x}^{′}\right) = min \left[1 , {e}^{- β \left(\text{Δ} E - \text{Δ} \tilde{E}\right)}\right]$$

where x′ = xₖ and x = x₀. In the above equation, the change in the value of the exact objective function 20 between the initial state x₀ and the preliminary estimated optimal state xₖ is given by ΔE = E(x′) - E(x) = E(xₖ) - E(x₀). In the correction step, the processor 12 is configured to correct for differences between the exact objective function 20 and the approximated objective function 24. When the approximated objective function 24 is a close approximation of the exact objective function 20, the quantity β(ΔE - ΔẼ) may be small. Thus, the acceptance fraction may be large even when E(x₀) and E(xₖ) differ significantly.

When the processor 12 accepts the updated state x′ in the correction iteration 38, the processor 12 may be further configured to output the updated state x′ as the estimated optimal state 42. When the processor 12 rejects the updated state x′ in the correction iteration 38, the processor 12 may be further configured to instead return to the initial state x₀ and repeat the estimation loop 30, including the plurality of fast-step iterations 32 and the correction iteration 38. The processor 12 may accordingly be configured to repeat the estimation loop 30 until the correction iteration 38 is accepted. The overall transition probability for k fast-step iterations 32 and a correction iteration 38 may be given by

$$\begin{matrix}{W}_{s} \left(x \to {x}^{′}\right) = \\ \left({\prod }_{i = 0}^{k} {\sum }_{{x}_{i} ∈ X} \left[{δ}_{{x}_{0} , x} {δ}_{{x}_{k} , {x}^{′}} \left({\prod }_{j = 1}^{k} \tilde{W} \left({x}_{j - 1} \to {x}_{j}\right)\right)\right]\right) {A}_{s} \left(x \to {x}^{′}\right)\end{matrix}$$

when x′ ≠ x and by

$${W}_{s} \left(x \to x\right) = 1 - {\sum }_{{x}^{′} ∈ X \backslash \left\{x\right\}} {W}_{s} \left(x \to {x}^{′}\right)$$

when x′ = x. In the above equations, x = x₀, x′ = xₖ, and δ is the Kronecker delta function.

Returning to FIG. 1, in some examples, the respective fast-step acceptance probabilities 34 of the plurality of fast-step iterations 32 may be determined based at least in part on a constraint function 44 in addition to the approximated objective function 24. For example, the constraint function 44 may be a function C(x) that equals zero if no constraints are violated and some other number if one or more constraints are violated. For example, C(x) may be equal to the number of violated constraints. In such examples, the fast-step acceptance probability 34 may be computed as

$$\tilde{A} \left(x \to {x}^{′}\right) = {δ}_{C \left({x}^{′}\right) , 0} min \left[1 , {e}^{- β \text{Δ} \tilde{E}}\right]$$

Thus, the fast-step acceptance probability 34 may be zero when one or more constraints are violated and may be computed as discussed above when each constraint is satisfied.

In another example, a penalty term may be included in the exponent in the equation for the fast-step acceptance probability. In such examples, each of the fast-step iterations 32 may have a fast-step acceptance probability 34 given by

$$\tilde{A} \left(x \to {x}^{′}\right) = min \left[1 , {e}^{- β \text{Δ} \tilde{E} - γ \text{Δ} C}\right]$$

where ΔC = C(x′) - C(x) is a change in a value of the constraint function 44 between the current state x and the updated state x′. In the above equation, γ is a constraint function weighting parameter that determines a level of strictness with which the one or more constraints are enforced. The equation for the fast-step acceptance probability 34 in this example approaches the equation for the fast-step acceptance probability 34 in the previous example as γ increases.

In the above examples in which a constraint function 44 is used when performing the plurality of fast-step iterations 32, the correction-step acceptance probability 40 does not depend upon constraint function 44.

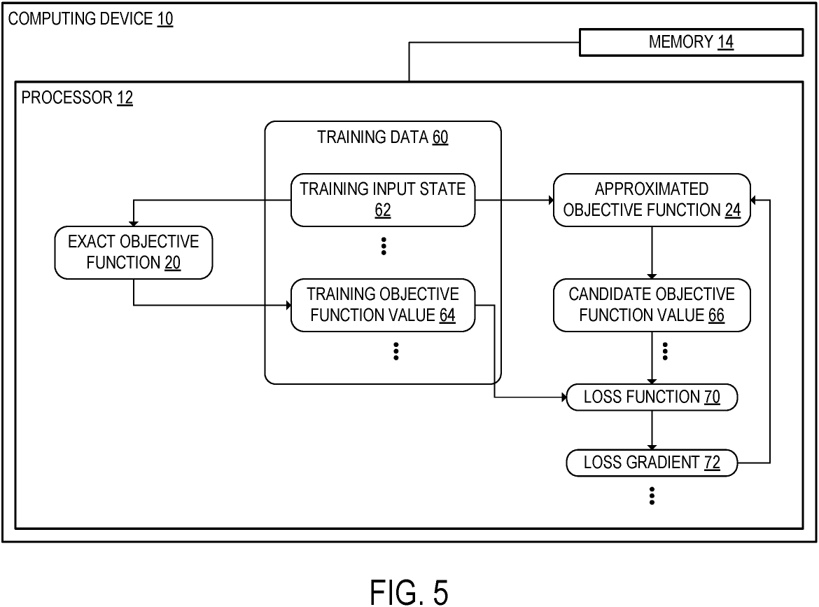

In some examples, as schematically depicted in FIG. 5, the approximated objective function 24 may be a machine learning model trained to simulate the exact objective function 20. As shown in FIG. 5, the training data 60 for the approximated objective function 24 may include a plurality of training input states 62. The training data 60 may further include a corresponding plurality of training objective function values 64 obtained by inputting the training input states 62 into the exact objective function 20. During training of the approximated objective function 24, the plurality of training input states 62 may be input into the approximated objective function 24, at which the processor 12 may be configured to compute a corresponding plurality of candidate objective function values 66.

The processor 12 may be further configured to input the training objective function values 64 and the candidate objective function values 66 into a loss function 70 at which the processor 12 is configured to compute a distance between the training objective function values 64 and the candidate objective function values 66. Based at least in part on the computed values of the loss function 70, the processor 12 may be further configured to compute a plurality of values of a loss gradient 72 of the loss function 70 with respect to parameters of the approximated objective function 24. The processor 12 may be further configured to perform gradient descent at the approximated objective function 24 based at least in part on the values of the loss gradient 72 to train approximated objective function 24 to simulate the exact objective function 20.

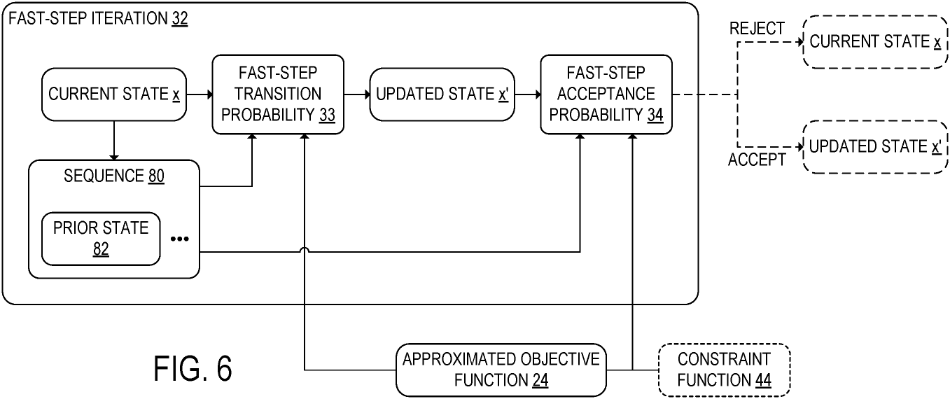

In some examples, as shown in FIG. 6, the Monte Carlo algorithm 28 may be a non-Markovian Monte Carlo algorithm. FIG. 6 schematically depicts a fast-step iteration in an example in which the processor 12 is configured to compute the preliminary estimated optimal state 36 based at least in part on a sequence 80 of one or more prior states 82 of the system in corresponding prior fast-step iterations. In some examples, the plurality of prior states 82 may be stored in the memory 14 of the computing device 10 such that the sequence 80 includes each of the prior states 82 taken in a current iteration of the estimation loop 30. In such examples, at each fast-step iteration 32 after the first fast-step iteration 32, the fast-step transition probability 33 and the fast-step acceptance probability 34 may be computed based at least in part on a full history of the prior states 82. Alternatively, the fast-step transition probability 33 and the fast-step acceptance probability 34 may be computed based at least in part on up to a predetermined number of most recent prior states 82.

The formalism of computing the fast-step transition probability 33 and the fast-step acceptance probability 34 using the sequence 80 of prior states 82 is discussed below, according to the example of FIG. 6. In this example, the states are elements of an N-dimensional state space X with elements {x}. For example, the state space X may have x ∈ R^{N} or x ∈ S^{N} = {-1,1}^{N}. The processor 12 is configured to sample a target distribution π(x). When the updated state is proposed, the updated state may be sampled from a distribution given by

$$g \left({x}^{′} , i , K \left|x\right)\right) = g \left({x}^{′} , i \left|K\right) , x\right) g \left(K \left|x\right)\right)$$

The distribution may, for example, be a Gibbs distribution. In the above equation, K ≤ N is an integer specifying the length of a sequence i = (i₁, i₂, ..., i_{K}) with elements {iₙ} that index the variables of x. In this example, K is assumed to be sampled independently of x, such that

$$g \left(K \left|x\right)\right) = g \left(K\right)$$

For example, the distribution of values of K may be a point mass in which each proposed sequence has the same length. As another example, the values of K may be uniformly distributed within an interval [Kₘᵢₙ, Kₘₐₓ] The reversal of the sequence i may be denoted as rev(i) = (i_{K}, i_{K-1}, ..., i₁).

In the fast-step iteration 32 shown in FIG. 6, the updated state x′ may be generated by selecting a candidate variable of the current state x to update. The updated state x′ may be generated based at least in part on the current state x and the sequence 80 of prior states 82. The distribution of updated states may be given by

$$g \left({x}^{′} , i \left|x\right) , K\right) = g \left({i}_{1} \left|x\right)\right) g \left({x}^{′} {\text{}}_{{i}_{1}} \left|{i}_{1} , x\right)\right) …$$

$$g \left({i}_{2} \left|{i}_{1} ,\right) {x}^{′} {\text{}}_{{i}_{1}} , x\right) g \left({{x}^{′}}_{{i}_{2}} \left|{x}^{′} {\text{}}_{{i}_{1}} , {i}_{1 : 2} , x\right)\right) …$$

$$g \left({i}_{K} \left|{i}_{1 : K - 1} ,\right) {x}^{′} {\text{}}_{{i}_{1 : K - 1}} , x\right) g \left({x}^{′} {\text{}}_{{i}_{K}} \left|{i}_{1 : K} , {x}^{′} {\text{}}_{{i}_{1 : K - 1}} , x\right)\right)$$

In the above equation, the dependence on K in the conditionals has been dropped. In the above equation, the index selection probabilities g(iₙ|i_{1:n-1}, x′_{i1:n-1}, x) may be non-Markovian. Thus, the fast-step transition probability 33 may be based at least in part on the prior states 82 of the system. In some examples, the processor 12 may be configured to bias the sampling of states to avoid revisiting state-space regions. The processor 12 may, for example, be configured to implement a tabu search algorithm using the equation for the distribution provided above. As another example, when the values of xᵢ ∈ {-1,1}, the conditional probabilities g(x′ᵢₙ x′ᵢₙ₋₁, i_{1:n}, x) may be selected such that the variable iₙ is flipped. In such an example, the conditional probabilities are given by

$$g \left({x}^{′} {\text{}}_{{i}_{n}} \left|{x}^{′} {\text{}}_{{i}_{n - 1}} , {i}_{1 : n} , x\right)\right) = {δ}_{{x}_{{i}_{n}}} \left(- {x}^{′} {\text{}}_{{i}_{n}}\right)$$

The processor 12 may be further configured to compute the fast-step acceptance probability 34 based at least in part on the sequence 80. The fast-step acceptance probability 34 may, in such examples, be defined as

$$α \left(x , {x}^{′} , i , K\right) ≜ min \left[1 , \frac{π \left({x}^{′}\right) g \left(x , \text{rev} \left(i\right) , K \left|{x}^{′}\right)\right)}{π \left(x\right) g \left({x}^{′} , i , K \left|x\right)\right)}\right]$$

Accordingly, the overall transition probability may be given by

$$T \left({x}^{′} , i , K \left|x\right)\right) ≜ g \left({x}^{′} , i , K \left|x\right)\right) α \left(x , {x}^{′} , i , K\right)$$

In some examples, additionally or alternatively to using the sequence 80 of prior states 82 when performing the plurality of fast-step iterations 32, the sequence 80 may be used to perform the correction iteration 38. When computing the correction-step acceptance probability 40, the processor 12 may be configured to use the above equations for g(x′,i,K|x) and a (x, x′, i, K) with E replaced by E - Ẽ when the correction-step acceptance probability 40 is computed. In examples in which the plurality of fast-step iterations 32 are non-Markovian, the estimation loop 30 overall may be Markovian. In the example of FIG. 6, the sequence 80 of prior states 82 is not reused between iterations of the estimation loop 30. Thus, each iteration of the estimation loop 30 is independent of the states visited in any prior estimation loops 30.

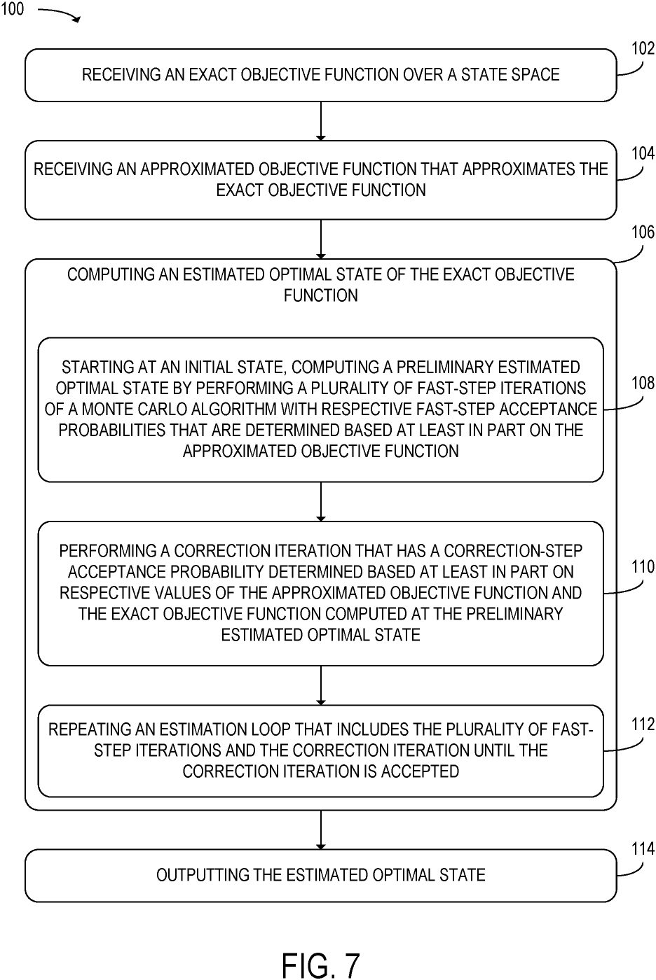

FIG. 7 shows a flowchart of a method 100 for use with a computing device to compute an estimated solution to an optimization problem. At step 102, the method 100 may include receiving an exact objective function over a state space. The exact objective function may be a function of one or more variables.

At step 104, the method 100 may further include receiving an approximated objective function that approximates the exact objective function. The approximated objective function may be a function over an approximated state space. The approximated state space may, in some examples, have fewer dimensions than the state space of the exact objective function. Additionally or alternatively, one or more of the variables of the approximated objective function may have a smaller range of input values relative to the exact objective function. The approximated objective function may, in some examples, be specified by a user at a GUI. In other examples, the approximated objective function may be programmatically generated. For example, the approximated objective function may be a machine learning model trained to simulate the exact objective function.

At step 106, the method 100 may further include computing an estimated optimal state of the exact objective function. The estimated optimal state may be an estimated minimum or and estimated maximum. At step 108, step 106 may include, starting at an initial state, computing a preliminary estimated optimal state by performing a plurality of fast-step iterations of a Monte Carlo algorithm. The Monte Carlo algorithm may be an MCMC algorithm, which may, for example, be a Metropolis-Hastings algorithm, a simulated annealing algorithm, simulated quantum annealing algorithm, a parallel tempering algorithm, a population annealing algorithm. Alternatively, the Monte Carlo algorithm may be a non-Markovian Monte Carlo algorithm such as a tabu search algorithm.

The fast-step iterations may have respective fast-step transition probabilities of transitioning from a current state to an updated state. In addition, the fast-step iterations may have respective fast-step acceptance probabilities of accepting the transitions to the updated states. The fast-step transition probabilities and the fast-step acceptance probabilities may be determined based at least in part on the approximated objective function. For example, computing the fast-step transition probabilities may include sampling from a Gibbs distribution over an approximated state space of the approximated objective function. Alternatively, some other probability distribution may be used. In addition, each of the fast-step iterations of the MCMC algorithm has a fast-step acceptance probability given by

$$\tilde{A} \left(x \to {x}^{′}\right) = min \left[1 , {e}^{- β \text{Δ} \tilde{E}}\right]$$

where x is a current state, x′ is an updated state, β is an inverse temperature, and ΔẼ is a change in a value of the approximated objective function between the current state and the updated state.

In some examples, the respective fast-step acceptance probabilities of the plurality of fast-step iterations may be determined based at least in part on a constraint function in addition to the approximated objective function. In such examples, each of the fast-step iterations of the MCMC algorithm may have a fast-step acceptance probability given by

$$\tilde{A} \left(x \to {x}^{′}\right) = min \left[1 , {e}^{- β \text{Δ} \tilde{E} - γ \text{Δ} C}\right]$$

where γ is a constraint function weighting parameter and ΔC is a change in a value of the constraint function between the current state and the updated state. As anotherexample, when a constraint function is used, the fast-step acceptance probability may be given by

$$\tilde{A} \left(x \to {x}^{′}\right) = {δ}_{C \left({x}^{′}\right) , 0} min \left[1 , {e}^{- β \text{Δ} \tilde{E}}\right]$$

in this example, the constraint function C is equal to zero when one or more constraints are all satisfied and is nonzero when at least one constraint is violated.

Additionally or alternatively, when the Monte Carlo algorithm is a non-Markovian Monte Carlo algorithm, performing the Monte Carlo algorithm may include computing the preliminary estimated optimal state based at least in part on a sequence of one or more prior states visited in prior fast-step iterations. At each fast-step iteration other than the first fast-step iteration, the fast-step transition probability and the fast-step acceptance probability may be computed based at least in part on a full or partial history of the prior states. In some examples, up to a predetermined number of prior states may be used in each fast-step iteration.

At step 110, the method 100 may further include performing a correction iteration. The correction iteration may have a correction-step acceptance probability of accepting the transition from the initial state to the preliminary estimated optimal state. The correction-step acceptance probability may be determined based at least in part on respective values of the approximated objective function and the exact objective function computed at the preliminary estimated optimal state. For example, the correction-step acceptance probability of the correction iteration may be given by

$${A}_{s} \left(x \to {x}^{′}\right) = min \left[1 , {e}^{- β \left(\text{Δ} E - \text{Δ} \tilde{E}\right)}\right]$$

where x is the initial state, x′ is the preliminary estimated optimal state, and ΔE is a change in a value of the exact objective function between the initial state and the preliminary estimated optimal state. In examples in which the Monte Carlo algorithm is a non-Markovian Monte Carlo algorithm in which a sequence of one or more priorstates is used when performing the plurality of fast-step iterations, the correction-step acceptance probability may also be computed based at least in part on the sequence of prior states.

In some examples, computing the estimated optimal state at step 106 may include, at step 112, repeating an estimation loop that includes the plurality of fast-step iterations and the correction iteration until the correction iteration is accepted. In such examples, when the preliminary estimated optimal state is rejected in the correction iteration, the estimation loop may return to the initial state of the system prior to the plurality of fast-step iterations. The plurality of fast-step iterations and the correction iteration may then be repeated.

At step 114, the method 100 may further include outputting the estimated optimal state. The estimated optimal state may be output to one or more additional computing processes. For example, the estimated optimal state may be output to the GUI for display to the user. As another example, the estimated optimal state may be output to a computing process used to programmatically control one or more hardware devices. Such a program may, for example, be an automated electrical grid control program or an automated computing resource allocation program.

Using the devices and methods discussed above, the objective function of an optimization problem may be approximated when computing an estimated solution. A correction step may then be performed on the preliminary estimated optimal state computed using the approximated objective function. Accordingly, the estimated optimal state may be computed efficiently even when the exact objective function is computationally expensive to evaluate. The devices and methods discussed above may allow numerical optimization algorithms to be used for a wider variety of problems than would be feasible using previously existing approaches.

In some embodiments, the methods and processes described herein may be tied to a computing system of one or more computing devices. In particular, such methods and processes may be implemented as a computer-application program or service, an application-programming interface (API), a library, and/or other computer-program product.

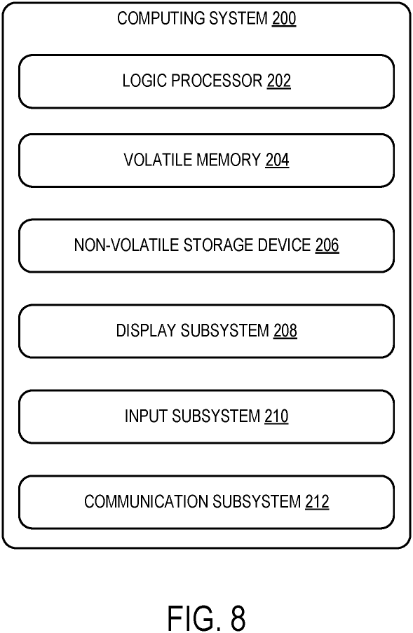

FIG. 8 schematically shows a non-limiting embodiment of a computing system 200 that can enact one or more of the methods and processes described above. Computing system 200 is shown in simplified form. Computing system 200 may embody the computing device 10 described above and illustrated in FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 8.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Non-volatile storage device 206 includes one or more physical devices configured to hold instructions executable by the logic processors to implement the methods and processes described herein. When such methods and processes are implemented, the state of non-volatile storage device 206 may be transformed-e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC /ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

Several aspects of the present disclosure are discussed below. According to one aspect of the present disclosure, a computing device is provided, including a processor configured to receive an exact objective function over a state space. The processor may be further configured to receive an approximated objective function that approximates the exact objective function. The processor may be further configured to compute an estimated optimal state of the exact objective function at least by, starting at an initial state, computing a preliminary estimated optimal state by performing a plurality of fast-step iterations of a Monte Carlo algorithm with respective fast-step acceptance probabilities that are determined based at least in part on the approximated objective function. Computing the estimated optimal state may further include performing a correction iteration that has a correction-step acceptance probability determined based at least in part on respective values of the approximated objective function and the exact obj ective function computed at the preliminary estimated optimal state. The processor may be further configured to output the estimated optimal state.

According to this aspect, the Monte Carlo algorithm may be a Markov chain Monte Carlo (MCMC) algorithm selected from the group consisting of a Metropolis-Hastings algorithm, a simulated annealing algorithm, simulated quantum annealing algorithm, a parallel tempering algorithm, and a population annealing algorithm.

According to this aspect, each of the fast-step iterations of the MCMC algorithm may have a fast-step acceptance probability given by

$$\tilde{A} \left(x \to {x}^{′}\right) = min \left[1 , {e}^{- β \text{Δ} \tilde{E}}\right]$$

where x is a current state, x′ is an updated state, β is an inverse temperature, and ΔẼ is a change in a value of the approximated objective function between the current state and the updated state.

According to this aspect, the correction-step acceptance probability of the correction iteration may be given by

$${A}_{s} \left(x \to {x}^{′}\right) = min \left[1 , {e}^{- β \left(\text{Δ} E - \text{Δ} \tilde{E}\right)}\right]$$

where ΔE is a change in a value of the exact objective function between the initial state and the preliminary estimated optimal state.

According to this aspect, the respective fast-step acceptance probabilities of the plurality of fast-step iterations may be determined based at least in part on a constraint function in addition to the approximated objective function.

According to this aspect, each of the fast-step iterations of the MCMC algorithm may have a fast-step acceptance probability given by

$$\tilde{A} \left(x \to {x}^{′}\right) = min \left[1 , {e}^{- β \text{Δ} \tilde{E} - γ \text{Δ} C}\right]$$

where x is a current state, x′ is an updated state, β is an inverse temperature, ΔẼ is a change in a value of the approximated objective function between the current state and the updated state, γ is a constraint function weighting parameter, and ΔC is a change in a value of the constraint function between the current state and the updated state.

According to this aspect, the processor may be configured to repeat an estimation loop that includes the plurality of fast-step iterations and the correction iteration until the correction iteration is accepted.

According to this aspect, the approximated objective function may have a reduced number of variables relative to the exact objective function.

According to this aspect, the approximated objective function may be a machine learning model trained to simulate the exact objective function.

According to this aspect, during each of the fast-step iterations of the Monte Carlo algorithm, the processor may be configured to sample from a Gibbs distribution over an approximated state space of the approximated objective function.

According to this aspect, the Monte Carlo algorithm may be a non-Markovian Monte Carlo algorithm in which the processor is configured to compute the preliminary estimated optimal state based at least in part on a sequence of one or more prior states.

According to another aspect of the present disclosure, a method for use with a computing device is provided. The method may include receiving an exact objective function over a state space. The method may further include receiving an approximated objective function that approximates the exact objective function. The method may further include computing an estimated optimal state of the exact obj ective function at least by, starting at an initial state, computing a preliminary estimated optimal state by performing a plurality of fast-step iterations of a Monte Carlo algorithm with respective fast-step acceptance probabilities that are determined based at least in part on the approximated objective function. The method may further include performing a correction iteration that has a correction-step acceptance probability determined based at least in part on respective values of the approximated objective function and the exact obj ective function computed at the preliminary estimated optimal state. The method may further include outputting the estimated optimal state.

According to this aspect, the Monte Carlo algorithm may be a Markov chain Monte Carlo (MCMC) algorithm selected from the group consisting of a Metropolis-Hastings algorithm, a simulated annealing algorithm, simulated quantum annealing algorithm, a parallel tempering algorithm, and a population annealing algorithm.

According to this aspect, each of the fast-step iterations of the MCMC algorithm may have a fast-step acceptance probability given by

$$\tilde{A} \left(x \to {x}^{′}\right) = min \left[1 , {e}^{- β \text{Δ} \tilde{E}}\right]$$

where x is a current state, x′ is an updated state, β is an inverse temperature, and ΔẼ is a change in a value of the approximated objective function between the current state and the updated state.

According to this aspect, the correction-step acceptance probability of the correction iteration may be given by

$${A}_{s} \left(x \to {x}^{′}\right) = min \left[1 , {e}^{- β \left(\text{Δ} E - \text{Δ} \tilde{E}\right)}\right]$$

where ΔE is a change in a value of the exact objective function between the initial state and the preliminary estimated optimal state.

According to this aspect, the respective fast-step acceptance probabilities of the plurality of fast-step iterations may be determined based at least in part on a constraint function in addition to the approximated objective function. Each of the fast-step iterations of the MCMC algorithm may have a fast-step acceptance probability given by

$$\tilde{A} \left(x \to {x}^{′}\right) = min \left[1 , {e}^{- β \text{Δ} \tilde{E} - γ \text{Δ} C}\right]$$

where x is a current state, x′ is an updated state, β is an inverse temperature, ΔẼ is a change in a value of the approximated objective function between the current state andthe updated state, γ is a constraint function weighting parameter, and ΔC is a change in a value of the constraint function between the current state and the updated state.

According to this aspect, the method may further include repeating an estimation loop that includes the plurality of fast-step iterations and the correction iteration until the correction iteration is accepted.

According to this aspect, the approximated objective function may be a machine learning model trained to simulate the exact objective function.

According to this aspect, the Monte Carlo algorithm may be a non-Markovian Monte Carlo algorithm that includes computing the preliminary estimated optimal state based at least in part on a sequence of one or more prior states.

According to another aspect of the present disclosure, a computing device is provided, including a processor configured to receive an exact objective function over a state space. The processor may be further configured to receive an approximated objective function that approximates the exact objective function. The processor may be further configured to compute an estimated optimal state of the exact objective function at least by performing one or more iterations of an estimation loop that includes a plurality of fast-step iterations and a correction iteration and that is repeated until the correction iteration is accepted. Performing the one or more iterations may include, starting at an initial state, computing a preliminary estimated optimal state by performing the plurality of fast-step iterations. Each of the fast-step iterations may be an iteration of a Markov chain Monte Carlo (MCMC) algorithm with a respective fast-step acceptance probability that is determined based at least in part on the approximated objective function. The MCMC algorithm may be selected from the group consisting of a Metropolis-Hastings algorithm, a simulated annealing algorithm, simulated quantum annealing algorithm, a parallel tempering algorithm, and a population annealing algorithm. Performing the one or more iterations may further include performing the correction iteration. The correction iteration may be an iteration of the MCMC algorithm that has a correction-step acceptance probability determined based at least in part on respective values of the approximated objective function and the exact objective function computed at the preliminary estimated optimal state. The processor may be further configured to output the estimated optimal state.

“And/or” as used herein is defined as the inclusive or V, as specified by the following truth table:

| | | |
|---|---|---|
| A | B | A V B |
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a processor configured to:
receive an exact objective function over a state space;
receive an approximated objective function that approximates the exact objective function;
compute an estimated optimal state of the exact objective function at least by:
starting at an initial state, computing a preliminary estimated optimal state by performing a plurality of fast-step iterations of a Monte Carlo algorithm with respective fast-step acceptance probabilities that are determined based at least in part on the approximated objective function; and
performing a correction iteration that has a correction-step acceptance probability determined based at least in part on respective values of the approximated objective function and the exact objective function computed at the preliminary estimated optimal state; and
output the estimated optimal state.

2. The computing device of claim 1, wherein the Monte Carlo algorithm is a Markov chain Monte Carlo (MCMC) algorithm selected from the group consisting of a Metropolis-Hastings algorithm, a simulated annealing algorithm, simulated quantum annealing algorithm, a parallel tempering algorithm, and a population annealing algorithm.

3. The computing device of claim 2, wherein each of the fast-step iterations of the MCMC algorithm has a fast-step acceptance probability given by
$$\tilde{A} \left(x \to {x}^{′}\right) = min \left[1 , {e}^{- β \text{Δ} \tilde{E}}\right]$$
where x is a current state, x′ is an updated state, β is an inverse temperature, and ΔẼ is a change in a value of the approximated objective function between the current state and the updated state.

4. The computing device of claim 3, wherein the correction-step acceptance probability of the correction iteration is given by
$${A}_{S} \left(x \to {x}^{′}\right) = min \left[1 , {e}^{- β \left(\text{Δ} E - \text{Δ} \tilde{E}\right)}\right]$$
where ΔE is a change in a value of the exact objective function between the initial state and the preliminary estimated optimal state.

5. The computing device of claim 2, wherein the respective fast-step acceptance probabilities of the plurality of fast-step iterations are determined based at least in part on a constraint function in addition to the approximated objective function.

6. The computing device of claim 5, wherein each of the fast-step iterations of the MCMC algorithm has a fast-step acceptance probability given by
$$\tilde{A} \left(x \to {x}^{′}\right) = min \left[1 , {e}^{- β \text{Δ} \tilde{E} - γ \text{Δ} C}\right]$$
where x is a current state, x′ is an updated state, β is an inverse temperature, ΔẼ is a change in a value of the approximated objective function between the current state and the updated state, γ is a constraint function weighting parameter, and ΔC is a change in a value of the constraint function between the current state and the updated state.

7. The computing device of claim 1, wherein the processor is configured to repeat an estimation loop that includes the plurality of fast-step iterations and the correction iteration until the correction iteration is accepted.

8. The computing device of claim 1, wherein the approximated objective function has a reduced number of variables relative to the exact objective function.

9. The computing device of claim 1, wherein the approximated objective function is a machine learning model trained to simulate the exact objective function.

10. The computing device of claim 1, wherein, during each of the fast-step iterations of the Monte Carlo algorithm, the processor is configured to sample from a Gibbs distribution over an approximated state space of the approximated objective function.

11. The computing device of claim 1, wherein the Monte Carlo algorithm is a non-Markovian Monte Carlo algorithm in which the processor is configured to compute the preliminary estimated optimal state based at least in part on a sequence of one or more prior states.

12. A method for use with a computing device, the method comprising:
receiving an exact objective function over a state space;
receiving an approximated objective function that approximates the exact objective function;
computing an estimated optimal state of the exact objective function at least by:
starting at an initial state, computing a preliminary estimated optimal state by performing a plurality of fast-step iterations of a Monte Carlo algorithm with respective fast-step acceptance probabilities that are determined based at least in part on the approximated objective function; and
performing a correction iteration that has a correction-step acceptance probability determined based at least in part on respective values of the approximated objective function and the exact objective function computed at the preliminary estimated optimal state; and
outputting the estimated optimal state.

13. The method of claim 12, wherein the Monte Carlo algorithm is a Markov chain Monte Carlo (MCMC) algorithm selected from the group consisting of a Metropolis-Hastings algorithm, a simulated annealing algorithm, simulated quantum annealing algorithm, a parallel tempering algorithm, and a population annealing algorithm.

14. The method of claim 13, wherein each of the fast-step iterations of the MCMC algorithm has a fast-step acceptance probability given by
$$\tilde{A} \left(x \to {x}^{′}\right) = min \left[1 , {e}^{- β \text{Δ} \tilde{E}}\right]$$
where x is a current state, x′ is an updated state, β is an inverse temperature, and ΔẼ is a change in a value of the approximated objective function between the current state and the updated state.

15. The method of claim 14, wherein the correction-step acceptance probability of the correction iteration is given by
$${A}_{S} \left(x \to {x}^{′}\right) = min \left[1 , {e}^{- β \left(\text{Δ} E - \text{Δ} \tilde{E}\right)}\right]$$
where ΔE is a change in a value of the exact objective function between the initial state and the preliminary estimated optimal state.

16. The method of claim 13, wherein:
the respective fast-step acceptance probabilities of the plurality of fast-step iterations are determined based at least in part on a constraint function in addition to the approximated objective function; and
each of the fast-step iterations of the MCMC algorithm has a fast-step acceptance probability given by
$$\tilde{A} \left(x \to {x}^{′}\right) = min \left[1 , {e}^{- β \text{Δ} \tilde{E} - γ \text{Δ} C}\right]$$
where x is a current state, x′ is an updated state, β is an inverse temperature, ΔẼ is a change in a value of the approximated objective function between the current state and the updated state, γ is a constraint function weighting parameter, and ΔC is a change in a value of the constraint function between the current state and the updated state.

17. The method of claim 12, further comprising repeating an estimation loop that includes the plurality of fast-step iterations and the correction iteration until the correction iteration is accepted.

18. The method of claim 12, wherein the approximated objective function is a machine learning model trained to simulate the exact objective function.

19. The method of claim 12, wherein the Monte Carlo algorithm is a non-Markovian Monte Carlo algorithm that includes computing the preliminary estimated optimal state based at least in part on a sequence of one or more prior states.

20. A computing device comprising:
a processor configured to:
receive an exact objective function over a state space;
receive an approximated objective function that approximates the exact objective function;
compute an estimated optimal state of the exact objective function at least by, in one or more iterations of an estimation loop that includes a plurality of fast-step iterations and a correction iteration and that is repeated until the correction iteration is accepted:
starting at an initial state, computing a preliminary estimated optimal state by performing the plurality of fast-step iterations, wherein:
each of the fast-step iterations is an iteration of a Markov chain Monte Carlo (MCMC) algorithm with a respective fast-step acceptance probability that is determined based at least in part on the approximated objective function; and
the MCMC algorithm is selected from the group consisting of a Metropolis-Hastings algorithm, a simulated annealing algorithm, simulated quantum annealing algorithm, a parallel tempering algorithm, and a population annealing algorithm; and
performing the correction iteration, wherein the correction iteration is an iteration of the MCMC algorithm that has a correction-step acceptance probability determined based at least in part on respective values of the approximated objective function and the exact objective function computed at the preliminary estimated optimal state; and
output the estimated optimal state.
